(19) United States
(12) Patent Application Publication
(10) Pub. No.: US 2003/0100274 A1
(43) Pub. Date: May 29, 2003

(54) Wireless Headset-Based Communication

(75) Inventor: Andrew Philip Brown, Temple Grafton (GB)

(73) Assignee: Sendo International Limited, (HK)

(21) Appl. No.: 10/065,895

(22) Filed: Nov. 27, 2002

(30) Foreign Application Priority Data
Nov. 28, 2001 (GB) GB 0128473.6

(51) Int. Cl. H04B 1/38; H04M 1/00

(52) U.S. Cl. 455/90; 455/556; 455/557; 455/550; 455/569

(57) ABSTRACT

### Abstract of Disclosure

A wireless headset-based communication arrangement (200, 300) comprises a first subscriber unit (210), a wireless headset (212) associated with the first subscriber unit (210) to form a wireless communication apparatus; and a detector within the wireless communication apparatus to detect a spatial proximity of at least one second subscriber unit (220) or second wireless headset (222). In response to the detection, the wireless headset (212) associated with the first subscriber unit (210) is adapted to communicate directly (230) with the at least one second subscriber unit (220) or second wireless headset (222). One advantage of the present invention is that the functionality of a hands-free headset and the functionality of inter-headset communication are combined into a single headset apparatus.

### Cross Reference to Related Applications

This application claims the benefit of UK Application No. GB 0128473.6 filed November 28, 2001.

### Background of Invention

### Field of the Invention

The present invention relates to a wireless headset-based communication arrangement, and in particular to an arrangement where a user uses a wireless headset with a subscriber communication unit to communicate with other subscriber units.

### Description of the Related Art

In the field of this invention it is known for wireless headsets to be used with communication devices, such as cordless telephones, mobile radios or cellular subscriber units. Wireless headsets are used to provide hands-free functionality of the communication device, and can be considered as a wireless extension of the device"s communication capability.

When used in such a hands-free mode of operation, the communication device routes the received, demodulated and decoded signal to a short-range transmitter, instead of a microphone. The radio transmission from the short-range transmitter is picked up from a wireless receiver in the headset, where it is processed and passed to an audio enunciator in the headset to be relayed to the headset user.

In an alternative application of wireless headsets, it is also known for wireless communications to be set up between groups of people, where each person in the group uses a wireless headset. Such group communication is beneficial when the users are highly mobile, and communication on the "shared" channel is not needed to be secure. Furthermore, such wireless headset use in group communications is sometimes used when normal one-to-one conversation is not practical. Further applications of such group-communication wireless headset arrangements would include sporting events, where the groups are members of a team, or the referees.

However, the above two applications for using wireless headsets are very distinct, and have so far been addressed with individual stand-alone solutions. The inventor of the present invention has recognized this fact and that no single headset, presently available, is capable of facilitating both of the above functions. Furthermore, the inventor of the present invention has recognized scenarios where a multi-purpose wireless headset would be an advantage.

A need therefore exists for an improved wireless headset, wherein the abovementioned disadvantages may be alleviated.

### Summary of Invention

In accordance with a first aspect of the present invention, there is provided a wireless headset-based communication arrangement, as claimed in Claim 1.

In accordance with a second aspect of the present invention, there is provided a wireless headset, as claimed in Claim 9.

In accordance with a third aspect of the present invention, there is provided a communication device, as claimed in Claim 10.

In accordance with a fourth aspect of the present invention, there is provided a wireless headset, as claimed in Claim 11.

Further aspects of the invention are as claimed in the dependent Claims.

In summary, the present invention proposes inter-alia, to facilitate direct communication, using a short-range wireless communication link between a first wireless headset and a second wireless headset or associated subscriber unit. The short-range link is preferably used as an alternative to a normal communication link when the second wireless headset or associated subscriber unit are detected as being spatially near the first wireless headset or its associated first subscriber unit. In this manner, a wireless headset is able to provide two modes of operation, a first being "hands-free" communication with its associated first subscriber unit, and a second mode being direct (inter-headset) communication with other wireless headsets (or their associated subscriber unit(s)).

### Brief Description of Drawings

Exemplary embodiments of the present invention will now be described, with reference to the accompanying drawings, in which:

FIG. 1 shows a block diagram of a subscriber unit and associated wireless headset arrangement adapted to support the inventive concepts of the preferred embodiments of the present invention;

FIG. 2 illustrates a subscriber unit/wireless headset communication arrangement, in accordance with a first preferred embodiment of the present invention; and

FIG. 3 illustrates a communication unit/wireless headset communication arrangement, in accordance with an alternative embodiment of the present invention.

### Detailed Description

The preferred embodiment of the present invention is described with reference to a portable cellular phone/wireless headset arrangement. However, it is within the contemplation of the present invention that the inventive concepts described herein are equally applicable to any other audio, video or image communication device, such as a personal data assistant (PDA), a portable or mobile radio, a laptop computer or a wirelessly networked Personal Computer (PC), where an optional short range communication link would be advantageous. It is envisaged that future wireless headset applications will not be limited to relaying audio communication, but will include relaying image or video signals to a screen attached to the headset, or to a virtual screen positioned in view of the headset user.

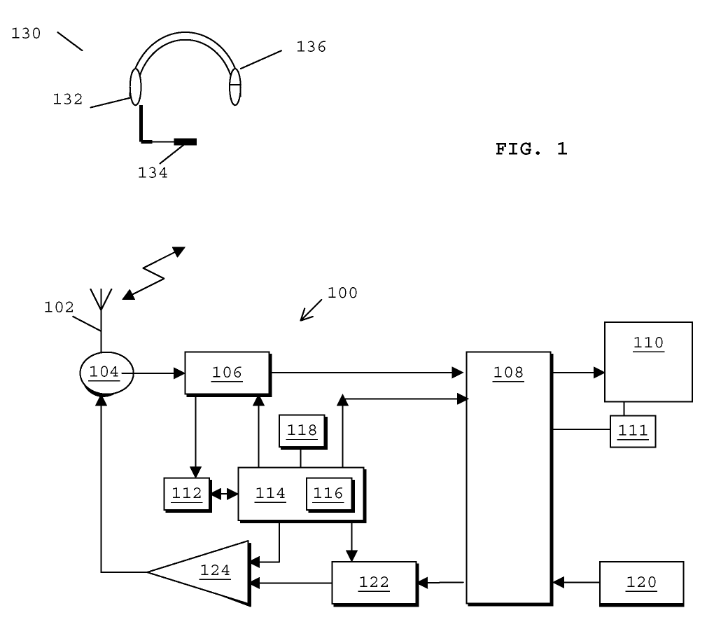

Referring first to FIG. 1, there is shown a block diagram of a cellular subscriber unit 100 adapted to support the inventive concepts of the preferred embodiments of the present invention. The subscriber unit 100 contains an antenna 102 preferably coupled to a duplex filter, antenna switch or circulator 104 that provides isolation between receiver and transmitter chains within the subscriber unit 100.

The receiver chain, as known in the art, includes scanning receiver front-end circuitry 106 (effectively providing reception, filtering and intermediate or base-band frequency conversion). The scanning front-end circuit 106 is serially coupled to a signal processing function 108. An output from the signal processing function 108 is provided to a suitable output device 110, which in accordance with the preferred embodiment of the present invention is a radio frequency interface port for transmitting short-range signals to an associated wireless headset. The radio frequency interface port 110 preferably includes a port driver 111.

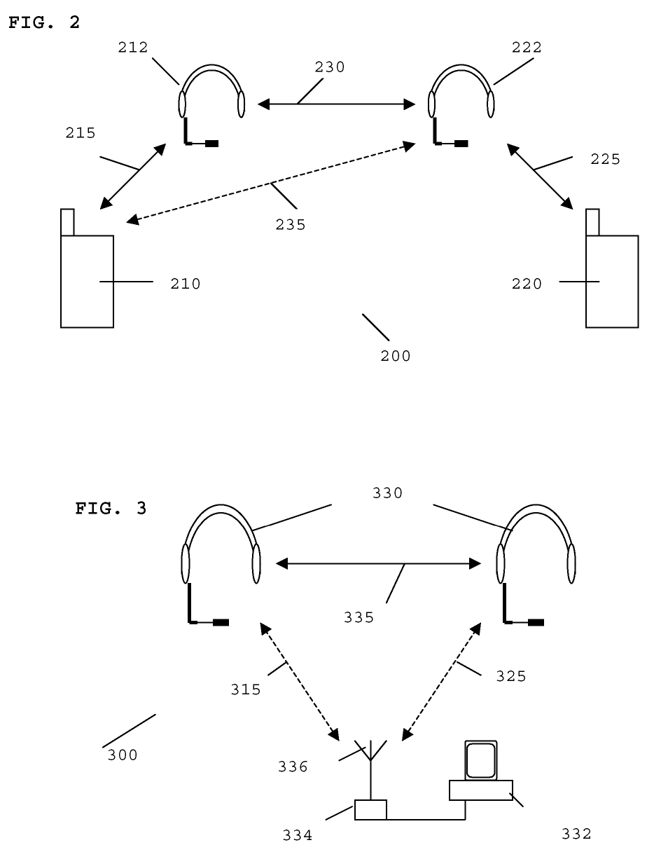

In the preferred embodiment of the present invention, the scanning front-end circuit 106 and the signal processing function 108 have been adapted to distinguish between communication on the subscriber unit"s usual wireless communication system, and a communication with a proximal communication unit/wireless headset on a short-range radio frequency (RF) link. Such a communication is described in greater detail with respect to FIG. 2.

The receiver chain also includes received signal strength indicator (RSSI) circuitry 112, which in turn is coupled to a controller 114 where the RSSI circuitry provides useful quality indicators on the received signal and the controller maintains overall subscriber unit control. The controller 114 is also coupled to the scanning receiver front-end circuitry 106 and the signal processing function 108 (generally realized by a digital signal processor (DSP)) for receiving a transmitted audio, video or image signal.

The controller 114 may therefore receive signal level information, bit error rate (BER) or frame erasure rate (FER) data from recovered information. The controller is also coupled to a memory device 116 that stores operating regimes, such as decoding/encoding functions and the like. In accordance with the preferred embodiment of the present invention, a proximity detector has been incorporated, operably coupled to the processor 108 and/or controller 114, to detect when a wireless headset has moved into the spatial vicinity of the headset associated with the subscriber unit 100.

Upon detecting the spatial proximity of a second subscriber unit or its associated headset, the primary subscriber unit 100 or its associated headset is provided with an opportunity to communicate directly with the second subscriber unit or its associated headset using a short range RF link. In this manner, the short-range communication link is used to supplement the standard communication of the subscriber unit, whilst minimizing the impact on the usual communication resource and any generated interference.

A timer 118 is operably coupled to the controller 114 to control the timing of operations (including transmission or reception of time-dependent signals) within the cellular subscriber unit 100. The timer, together with the port driver 111, processor 108 and/or controller 114, has also been adapted to control the switching of communications from a usual communication link, for example a GSM or 3^{rd} generation cellular (3G) communication link to a more appropriate short range RF link.

The wireless headset 130 associated with the subscriber unit 100 is preferably comprised of:

(i) One (monaural) or two (bi-aural) earpieces 132;

(ii) A microphone 134;

(iii) RF transmit and receive elements 136 and a controller for wireless (e.g. bluetooth) headsets; and, in some cases:

(iv) A remote answer switch/button (not shown); and

(v) A second noise cancellation button (not shown).

As indicated, each wireless headset comprises RF transmitting and receiving elements, allowing two-way communications to at least one other device. Furthermore, in an alternative embodiment of the present invention, the wireless headset includes a detector, in a similar manner to that described earlier with respect to the subscriber unit. Each wireless headset comprises a microprocessor to control communication etc, as well as memory for storing application software etc. In accordance with the preferred embodiment of the present invention, a wireless headset(s) has been adapted with regard to the detection of signals destined for that headset, and how such received signals are controlled, for example via the man machine interface (MMI) of the cellular phone or computer.

The preferred operation is now described in greater detail with reference to FIG. 2, where an example of a wireless communication arrangement 200 is illustrated, in accordance with a preferred embodiment of the present invention. The arrangement 200 comprises a first communication device, which for the illustrated embodiment is in the form of a subscriber unit 210, and an associated wireless headset 212. The subscriber unit 210 and the wireless headset 212 are operably coupled and capable of providing hands-free functionality to a user of the subscriber unit 210.

FIG. 2 further illustrates a second communication device 220, which for the illustrated embodiment is in the form of a second subscriber unit 220, and a second associated wireless headset 222. The second subscriber unit 220 and second wireless headset 222 are also capable of providing hands-free functionality to a user of the second subscriber unit 220.

In particular, according to the present invention, the first subscriber unit 210 (or associated wireless headset 212) has been adapted to include a headset detector, as described with regard to FIG. 1, capable of detecting the presence of the second wireless headset 222, when the second wireless headset 222 (or the second subscriber unit 220) is spatially near the first communication device 210. In the context of the preferred embodiment of the present invention, it is envisaged that the detector recognizes, for example, when the second wireless headset 222 is within, say, ten meters of the first communication unit 210 or its associated wireless headset 212.

In the alternative preferred embodiment, where the wireless headset 212 is provided with a RF detector that is capable of detecting the presence of the second wireless headset 222, it is envisaged that the first wireless headset 212 informs its associated subscriber unit 210 of the proximal wireless headset(s) or subscriber unit(s).

When the second wireless headset 222 is detected as being within range 135 of the first subscriber unit 210 (or first wireless headset 212), a user of the first subscriber unit 210 may initiate wireless communication between the first wireless headset 212 and the second wireless headset 222. This provides a means for the user of the first subscriber unit 210 to communicate with a user of the second subscriber unit 220 by way of direct short-range wireless communication between the wireless headsets 212 and 222. It is further envisaged that such short-range communication could be effected using simple RF communication, perhaps initiating the use of pre-stored messages stored within the respective headsets.

Preferably, each wireless headset has a substantially unique identification (ID). For example, since each headset is associated with a particular subscriber unit, each headset may be configured to use the telephone number of the respective subscriber unit as its ID. When the subscriber unit 210 detects the presence of the second wireless headset 222, it is envisaged that the subscriber unit 210 may request the ID of the second wireless headset 222, or the second wireless headset 222 may be configured to automatically or periodically transmit its ID. The first subscriber unit 210 may then use the second subscriber unit's ID in differentiating communication between different headsets.

Where the ID is the telephone number of the second subscriber unit 220, the subscriber unit 210 may search through its phone book in order to identify the user of the second wireless headset 222.

Preferably the subscriber unit 210 retains a list of the wireless headsets within its range, such that when the user wants to communicate with a specific user of another headset they simply search through the list until they find the required ID (or name if the number matches an entry in the phone book). On selecting the required ID or name, the subscriber unit 210 sends an instruction to its respective headset 212, instructing the headset to initiate communication 130 with the second wireless headset 222 having the selected ID. On receipt of this instruction, the first wireless headset 212 may initiate communication with the second wireless headset 222 by, for example, sending a call request to the second wireless headset 222.

When the second wireless headset 222 receives such a request for communication from the first wireless headset 212, the second wireless headset 222 may automatically establish communication with the first wireless headset 210 to allow the users of the first and second headsets 221, 222 to communicate directly.

Alternatively, the second wireless headset 222 may require consent from its user before establishing communication with the first wireless headset 212. For example, the second wireless headset 222 may transmit a signal to the second subscriber unit 220, on receipt of which the second subscriber unit 220 displays the ID/name of the first wireless headset 212 or user. It is also envisaged that the second wireless headset 222 may further provide an audible signal to its user to alert the user of a request to communicate. The user may then accept or decline the request by interacting with a user interface on the second subscriber unit 220.

A corresponding signal may then be transmitted from the second subscriber unit 220 to the second wireless headset 222. If the user has accepted the request for communication, then the second wireless headset 222 will establish communication with the first wireless headset 212. Alternatively, if the user has declined the request for communication, the second wireless headset 222 may transmit a corresponding "declining" message to the first wireless headset 212.

When the user of either of the first or second wireless headsets 212, 222 wishes to terminate communication, that user can initiate termination of the communication via the subscriber unit 210, 220. When the respective user wishes to terminate communication, the subscriber unit 210 or 220 preferably transmits an instruction to the headset 212, 222 instructing it to end communication. On receipt of this instruction the headset 212, 222 may transmit a signal to the other headset informing it that it is terminating communication, or alternatively the headset 212, 222 may simply terminate communication.

Preferably the headset 212 is configured to be capable of establishing communication with a plurality of headsets, to allow for a group communication between three or more users of headsets. Furthermore, it is envisaged that where group communication is supported a user is able to broadcast to all wireless headsets within range of its wireless headset.

In the illustrated embodiment, the wireless headsets are used in conjunction with subscriber units. It is within the contemplation of the present invention that the wireless headsets may alternatively by used in conjunction with fixed line telephone systems, for example in a call center. In this case, the ID of each headset may be, for example, the extension number of the telephone terminal being utilized by an operator.

During a call, the user of the first subscriber unit 210 utilizes the headset 212 for hands-free functionality. If the user of the first subscriber unit 210 wishes for the user of the second wireless headset 222/second subscriber unit 220 to be included in the call, it is preferably given the option of communicating with the second wireless headset 222, either directly or via the first wireless headset 212.

According to a further aspect of the preferred first embodiment of the present invention, it is envisioned that the users of the first and second subscriber units 210, 220 may switch between communication technologies. For example, let us assume that if the users of subscriber units 210, 220 are communicating via a GSM network, and utilizing the wireless headsets 212, 222 for hands-free functionality. Let us further assume that the wireless headsets 212, 222 subsequently come into close spatial proximity with one another during their phone call, such that the subscriber units and/or headsets detect one another"s presence. In such a case, it is envisaged that the subscriber units utilizing the detector in the respective subscriber unit or headset will indicate as such to the users.

The users may then switch from communicating over the GSM network to direct wireless communication using the short range RF functionality of the headsets. Alternatively, the subscriber units and/or headsets may automatically switch from communicating over the GSM network to direct communication. In order to limit interference, it is envisaged that this short-range wireless communication between a subscriber unit and a non-associated headset (or two or more headsets) may utilize alternative communication technologies, such as a spread-spectrum frequency-hopping scheme.

Furthermore, it is envisaged that a headset being used in conjunction with a subscriber unit, as in the first preferred embodiment, may be capable of communicating with a headset used in conjunction with a fixed line telephone system or a computer system.

It is also envisioned that the wireless headsets may be used in conjunction with devices other than typical wireless communications devices, for example a computer system of even a personal digital assistant (PDA). An example of such an arrangement is illustrated in FIG. 3.

In FIG. 3, a plurality of wireless headsets 330, according to a second embodiment of the present invention, are coordinated by a computer system 332. The computer system 332 includes or is connected to a transceiver 334 and antenna 336 for wireless communication 215, 225 with a plurality of wireless headsets 330. One application of such communications from a central control to a number of wireless headsets would be for broadcast or dispatch communications.

A further envisaged application for this embodiment would be within an office or building that has a phone system based on an exchange which routes calls to say, a computer instead of to a telephone. The computers would then be configured to communicate with the headsets. Furthermore, this application could make use of a local area network (LAN), rather than individual phone lines.

A yet further application of the inventive concepts hereinbefore described is that, instead of the headsets being used for telephone calls, the headsets are used for voice recognition by the computer, as well as for inter-headset communication.

It will be understood that the wireless headset communication arrangement, as described above, provides both:

(i)The functionality of a hands-free headset when operably coupled to, and solely communicating with, its associated communication device; and

(ii)The functionality of inter-headset communication, between a plurality of communication units, in a single headset apparatus.

(iii)A communication can take place, or be initiated, using a short range RF link, rather than use the usual system transmission and bandwidth that utilizes valuable resource that creates undesirable interference, particularly in highly populated areas.

Whilst the specific and preferred implementations of the embodiments of the present invention are described above, it is clear that one skilled in the art could readily apply variations and modifications of such inventive concepts.

Thus, an improved wireless headset communication arrangement has been described wherein the aforementioned disadvantages associated with prior art arrangements have been substantially alleviated.

Claims

1. A wireless headset-based communication arrangement, comprising:
a first subscriber unit;
a wireless headset associated with said first subscriber unit to form a wireless communication apparatus;
a detector within the wireless communication apparatus to detect a spatial proximity of at least one second subscriber unit or second wireless headset; and
in response to said detection, said wireless headset associated with said first subscriber unit is adapted to communicate directly with said at least one second subscriber unit or second wireless headset.

2. The wireless headset-based communication arrangement according to Claim 1, wherein said direct communication is a short-range wireless communication.

3. The wireless headset-based communication arrangement according to Claim 1, wherein said at least one second subscriber unit or second wireless headset is a plurality of subscriber units or wireless headsets such that group communications are implemented between said wireless headset associated with said first subscriber unit and the plurality of subscriber units or wireless headsets.

4. The wireless headset-based communication arrangement according to Claim 3, wherein said wireless headset associated with said first subscriber unit provides broadcast communication to any of the plurality of subscriber units or wireless headsets within range of said wireless headset associated with said first subscriber unit.

5. The wireless headset-based communication arrangement according to Claim 1, wherein an identification is associated with the at least one second subscriber unit and the first subscriber unit uses the identification to communicate with the at least one second subscriber unit or its associated headset.

6. The wireless headset-based communication arrangement according to Claim 1, wherein said detector is contained within said first subscriber unit or said wireless headset.

7. The wireless headset-based communication arrangement according to Claim 1, wherein said detector detects a presence of a proximal at least one second subscriber unit or associated wireless headset when within the order of ten meters of said detector.

8. The wireless headset-based communication arrangement according to Claim 1, wherein said first subscriber unit is one of: a cellular telephone, a mobile or portable radio, a personal digital assistant, a computer.

9. A wireless headset adapted to operate in the wireless headset-based communication arrangement of Claim 1.

10. A communication device adapted to operate in the wireless headset-based communication arrangement of Claim 1.

11. A wireless headset comprising:
a transmitter;
a receiver for communicating with its associated communication unit in a first mode of operation, and
a processor for selecting a second mode of operation of the wireless headset to communicate directly with one or more alternative communication units or wireless headsets of said alternative communication units.

12. The wireless headset according to Claim 11, wherein the wireless headset comprises a detector operably coupled to the processor, and said second mode of operation is selected by the wireless headset based upon a spatial proximity of said one or more alternative communication units or wireless headsets of said alternative communication units as determined by the detector.
